(19) United States
(12) Patent Application Publication
(10) Pub. No.: US 2026/0161455 A1
(43) Pub. Date: Jun. 11, 2026

(54) CREDIT-BASED TECHNIQUES AND MECHANISMS FOR DETERMINING AN ENABLEMENT STATE OF A PREFETCH FILTER

(71) Applicant: Intel Corporation, Santa Clara, CA (US)

(72) Inventor: Seth Pugsley, Salt Lake City, UT (US)

(73) Assignee: Intel Corporation, Santa Clara, CA (US)

(21) Appl. No.: 18/970,713

(22) Filed: Dec. 5, 2024

(51) Int. Cl. G06F 9/50; G06F 9/30

(52) U.S. Cl. CPC G06F 9/5016; G06F 9/30047; G06F 9/5055

(57) ABSTRACT

Techniques and mechanisms for determining a state of enablement of a prefetch filter. In an embodiment, circuitry of a processor maintains a variable which indicates an amount of prefetch credit which is currently allocated to a region of a cache or of other suitable memory resource. The value of the variable is updated based on prefetch accesses to the memory resource, and is further updated based on demand memory accesses to the memory resource. The variable is evaluated, based on a threshold minimum level of credit, to determine whether a prefetch filter is to be enabled or disabled for the memory resource. In another embodiment, the amount of the prefetch credit is incrementally decreased based on the detection of a prefetch access, and is increased to a predetermined maximum credit amount based on the detection of a demand memory access.

### BACKGROUND

### 1. Technical Field

This disclosure generally relates to processor operations and more particularly, but not exclusively, to a selective enablement of a prefetch filter.

### 2. Background Art

Multiprocessor systems are becoming more and more common. Applications of multiprocessor systems include dynamic domain partitioning all the way down to desktop computing. In order to take advantage of some multiprocessor systems, code of a thread to be executed is separated by schedulers to various processing entities for out-of-order execution. Out-of-order execution executes instructions as input to such instructions is made available. Thus, an instruction that appears later in a code sequence is subject to being executed before an instruction appearing earlier in the code sequence.

Some modern computer processors include functionality to speculatively prefetch data during execution. For example, such a processor facilitates execution of a software program by prefetching data to be processed by the program, such as text or video information. The processor prefetches such data in an attempt to reduce the overall execution time of the software program.

As successive generations of processors continue to increase in number, variety, and capability, there is expected to be an increasing premium placed on improvements to efficient provisioning of data in support of program execution.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system 100 to evaluate whether a prefetch filter is to be applied according to an embodiment.

FIG. 2 shows a flow diagram illustrating features of a method to maintain a credit metric as a basis for selectively applying a prefetch filter according to an embodiment.

FIG. 3 shows a block diagram illustrating features of a processor 300 to apply a prefetch filter according to an embodiment.

FIG. 4 shows a flow diagram illustrating features of a method to determine a value of a prefetch credit metric according to an embodiment.

FIG. 5 shows a flow diagram illustrating features of a method to determine an enablement state of a prefetch filter according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

Embodiments discussed herein variously provide techniques and mechanisms for determining a state of enablement of a prefetch filter. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some embodiments variously facilitate the (re)configurability of one or more prefetch functionalities which, for example, each correspond to a different respective set of memory resources. For example, a configuration state of a prefetch filter comprises an enablement state of said filter, wherein the enablement state, at a given time, is one of an enabled state or a disabled state. In various embodiments, enabling a given prefetch filter comprises, or otherwise corresponds to, disabling or otherwise limiting a prefetch functionality which corresponds to said filter. Similarly, disabling said prefetch filter comprises, or otherwise corresponds to, enabling the corresponding prefetch functionality.

As used herein, “demand memory access” refers to a type of access to a given memory location which takes place as part of the execution of a program instruction which is explicitly to read (e.g., load) information from, or write (e.g., store) information to, said memory location. By contrast, “prefetch access” refers herein to another type of access to a given memory location which takes place which takes place in the absence of any program instruction which is explicitly to read information from, or write information to, said memory location.

As used herein, “address space” refers to a set of addresses which are to directly or indirectly identify respective memory locations each in a respective resource of one or more memory resources of a given device or system. A given portion (or “slice”) of such an address space comprises, for example, only a sub-set of all such addresses, wherein the respective addresses in a given slice are for memory locations each in the same one memory region (e.g., the same page of a cache or other memory).

In various embodiments, multiple slices of an address space each correspond to a different respective page or other suitable memory region. In some cases, a given slice comprises multiple addresses which, for example, are numerically contiguous with each other (although some embodiments are not limited in this regard). Additionally or alternatively, each location in a contiguous memory region corresponds to a respective address in the same slice (although some embodiments are not limited in this regard). In various embodiments, some or all of an address space is sliced according to any of various arbitrary functions—e.g., wherein a set of numerically contiguous addresses in an address space is striped across multiple slices.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which supports prefetch filter functionality.

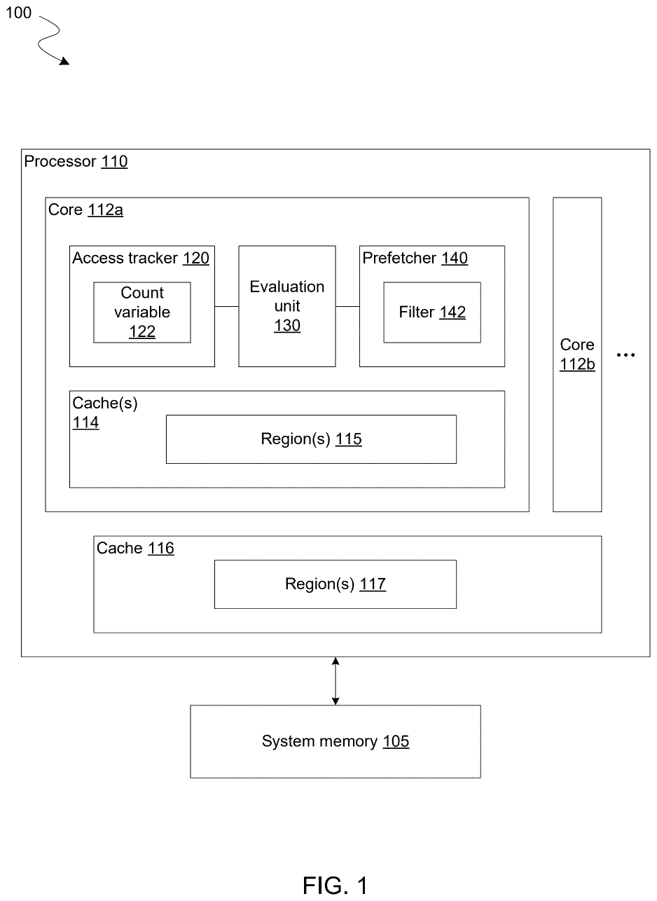

FIG. 1 shows a system 100 which evaluates whether a prefetch filter is to be applied according to an embodiment. The system 100 illustrates features of one example embodiment wherein a metric of prefetch credit is maintained at a processor for a corresponding portion of a memory resource. The metric is updated based on accesses to the memory resource portion—e.g., wherein a prefetch access to the memory resource portion reduces available prefetch credit. In an embodiment, the metric is used as a basis for determining whether future prefetch accesses are to be prevented or otherwise limited.

In some embodiments, system 100 is all or a portion of an electronic device or component. For example, system 100 is (or otherwise comprises) a cellular telephone, a computer, a server, a network device, a system on a chip (SoC), a controller, a wireless transceiver, a power supply unit, or the like. Furthermore, in some embodiments, system 100 is any of various suitable groupings of related or interconnected devices, such as a datacenter, a computing cluster, etc.

As shown in FIG. 1, system 100 comprises a processor 110 and a system memory 105 which is operatively coupled thereto. Although not shown in FIG. 1, system 100 includes additional components, in some embodiments. In one or more embodiments, system memory 105 is implemented with any of various suitable type(s) of computer memory (e.g., dynamic random access memory (DRAM), static random-access memory (SRAM), non-volatile memory (NVM), a combination of DRAM and NVM, etc.).

Processor 110 is any of various suitable general purpose hardware processors (e.g., a central processing unit (CPU)) or special purpose hardware processors, for example. As shown, processor 110 includes any number of one or more processing cores 112 (e.g., including the illustrative cores 112a, 112b shown). A given one such core 112 facilitates functionality of a central processing unit, graphics processing unit, or the like—e.g., wherein said core 112 includes circuitry adapted from any of various conventional core architectures. For example, core 112a comprises any of a variety of suitable execution units (not shown)—e.g., including one or more arithmetic logic units (ALUs), one or more load pipelines, one or more store pipelines, and/or the like—circuitry of which is to perform algorithms for executing micro-operations and/or other such instructions, in accordance with the embodiment described herein.

In the example embodiment shown, processor 110 includes one or more caches to cache instructions and/or data. By way of illustration and not limitation, core 112a comprises one or more caches 114 which include, but are not limited to, some or all of a level one (L1) cache, and a level two (L2) cache. Alternatively or in addition, a cache 116 is shared by multiple ones of cores 112—e.g., wherein cache 116 is a last level cache (LLC) in a cache hierarchy of processor 110. Some embodiments are not limited to a particular number or configuration of the one or more caches of processor 110.

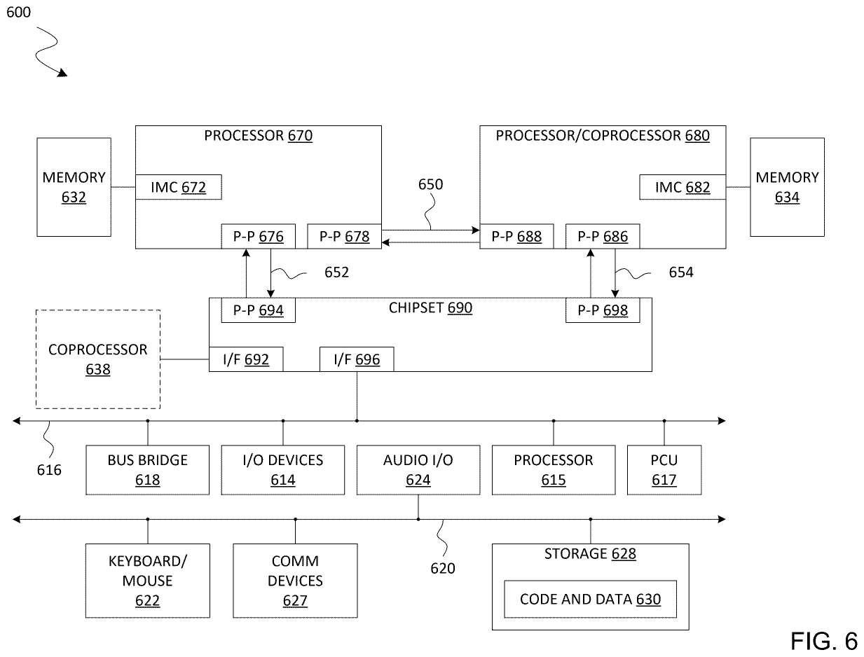

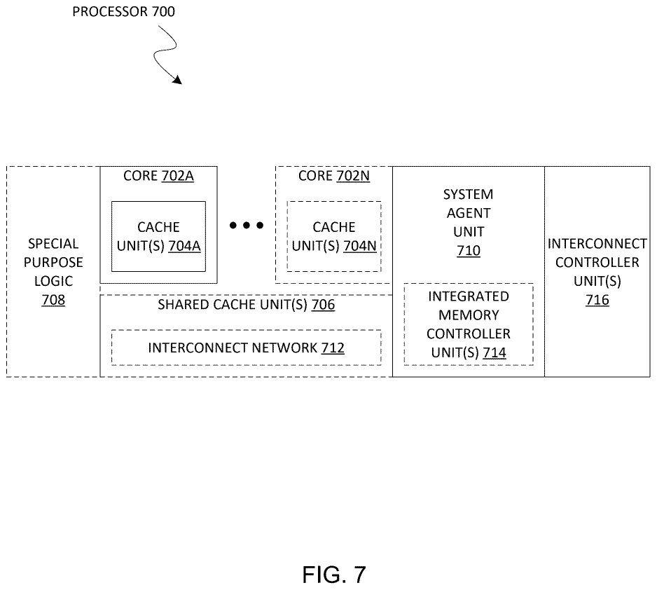

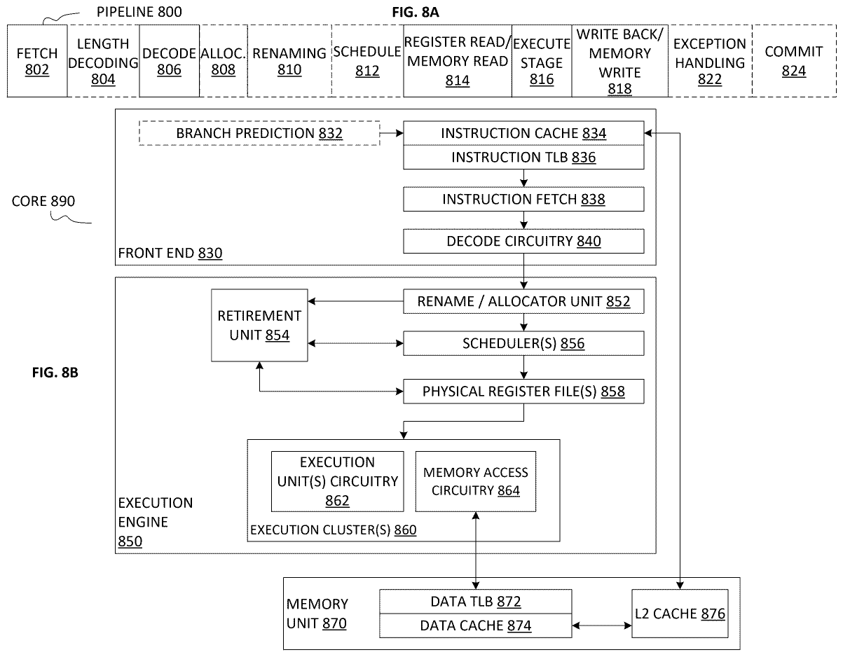

In some embodiments, circuitry of processor 110 is adapted from, and/or is incorporated with, any of various suitable processor architectures. By way of illustration and not limitation, any of various suitable embodiments of processor 110 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In the example embodiment shown, processor 110 comprises a prefetcher 140 which, for example, is implemented with circuitry and/or micro-architecture of the core 112a. In another embodiment, some or all of prefetcher 140 is implemented with other circuitry of system 100—e.g., including uncore circuitry of processor 110. Note that, while FIG. 1 only shows prefetcher 140 as included in one core 112a, any or all cores 112 include the same or similar prefetch circuitry, in some embodiments.

In some embodiments, prefetcher 140 initiates, manages, and/or executes prefetch requests in the respective core 112a. For example, prefetcher 140 analyzes memory access requests to determine a data usage pattern in the core 112a. Prefetcher 140 uses the usage pattern to predict data that will be needed by the core 112a in a given time window. Prefetcher 140 then automatically generates a prefetch request for the predicted data. Further, in some embodiments, prefetcher 140 executes the prefetch request to read the predicted data from a repository (e.g., system memory 105, of from a cache of processor 110), and stores the read data in a (different) cache of processor 110. In various embodiments, the generation of a prefetch request with prefetcher 140 includes operations that, for example, are adapted from conventional prefetch techniques (which are not detailed herein to avoid obscuring features of said embodiments).

To facilitate efficient prefetching according to some embodiments, prefetcher 140 includes, is coupled to access, or otherwise operates with, one or more prefetch filters (e.g., including the illustrative filter 142 shown) each of which, when enabled, is to prevent or otherwise limit the generation or servicing of one or more prefetch requests.

In some embodiments, prefetch (re)configurability is provided—e.g., at a slice-specific (or, for example, a corresponding region-specific) level of granularity. By way of illustration and not limitation, prefetcher 140 is operable to selectively enable or disable a prefetch filter which only applies to one slice of an address space (and, for example, only a memory region which is addressable using addresses in said address space). In one such embodiment, prefetcher 140 is operable to selectively enable or disable any of multiple prefetch filters, independent of each other, where each such filter applies to prefetching for a different respective address slice (e.g., where each such filter applies to prefetching to or from a different respective memory region).

In various embodiments, one or more memory regions (e.g., pages) of system 100 each correspond to a different respective prefetch filter, wherein a given one such prefetch filter—when enabled—is to prevent or otherwise limit prefetching to and/or from the corresponding memory region. By way of illustration and not limitation, cache(s) 114 comprise one or more regions 115 that, for example, each comprise a respective one or more pages, or a portion of such a page—e.g., wherein each such region comprises a respective plurality of cache lines. In one such embodiment, some or all of region(s) 115 each correspond to a different respective slice of an address space. Alternatively or in addition, cache 116 similarly comprises one or more regions 117 which, for example, each correspond to a different respective slice of an address space.

In an illustrative scenario according to one embodiment, some or all of region(s) 115 and/or some or all of region(s) 117 are dedicated, during operation of processor 110, each to a different respective address slice. By way of illustration and not limitation, region(s) 117 are dedicated each to correspond to a different respective region of system memory 105 (or other such memory coupled to processor 110). Alternatively or in addition, region(s) 115 are dedicated each to correspond to a different respective one of region(s) 117 and/or each to a different respective region of system memory 105. For a given one such cache region, cache lines of the region are to cache only data which is retrieved from—or, alternatively, which is available to be retrieved only to—a memory region which is indicated by a corresponding slice of the address space.

In various embodiments, circuitry of processor 110 is operable to determine an enablement state of a prefetch filter based on a variable—referred to herein as a “count variable”—which specifies or otherwise indicates an amount of credit, with respect to the provisioning of a prefetch functionality, that a given slice (and, correspondingly, a memory resource which is associated with said slice) is currently allocated. The amount of credit is to serve as a basis for determining—e.g., based on some threshold minimum credit level—whether a prefetch filter (in some embodiments, a slice-specific filter) is to be transitioned between an enabled state and a disabled state. In one such embodiment, an amount of prefetch credit for a given slice is subject to being consumed based on the detection of a prefetch access, actual or expected, which targets the slice (e.g., which uses an address which is within, or otherwise corresponds to, the slice). In some embodiments, the prefetch credit is also subject to being increased by some amount based on the detection of a demand memory access (actual or expected) which targets the slice.

By way of illustration and not limitation, core 112a further comprises an access tracker 120 which provides functionality to maintain a count variable 122 which corresponds to a particular one (and only one) slice of an address space. For example, each address of the slice specifies, directly or indirectly, a different respective location in one of region(s) 115, in one of region(s) 117, and/or a region (not shown) in system memory 105.

In an embodiment, access tracker 120 comprises circuitry which is operable to detect that a prefetch (actual or expected) is to target the slice in question—e.g., wherein access tracker 120 is coupled to snoop or otherwise detect an address in a prefetch request. Based on the detected prefetch, access tracker 120 decrements or otherwise updates a count variable 122 to indicate a decreased amount of a credit which corresponds to the slice.

In one such embodiment, access tracker 120 is further operable to detect that a demand memory access is to target the slice. Based on the detected demand memory access, access tracker 120 updates the count variable 122 to indicate an increased amount of the credit which corresponds to the slice. In various embodiments, updates to count variable 122, based on the detection of respective prefetch accesses, are each to decrease the corresponding prefetch credit by a same incremental amount. By contrast, an update to count variable 122, based on the detection of a single demand memory access, is to (re)set the corresponding prefetch credit to some predetermined maximum amount.

Accordingly, at various times, an enablement state of filter 142, for example, is subject to being (re)evaluated, based on count variable 122, to determine whether prefetching is to be enabled, or disabled, for the slice (and, accordingly, for the memory region corresponding to the slice). For example, core 112a further comprises an evaluation unit 130, coupled to access tracker 120, which detects, based on the count variable 122 a condition (referred to herein as a “credit deficit condition”) comprising a failure of a current amount of the credit to satisfy a predefined minimum credit criteria.

In one such embodiment, evaluation unit 130 is coupled to indicate to prefetcher 140 whether a particular prefetch filter, such as filter 142, is to be (re)configured to have a particular enablement state—i.e., a particular one of an enabled state or a disabled state. By way of illustration and not limitation, evaluation unit 130 generates one or more signals to indicate, based on the detected credit deficit condition, that filter 142 is to enable a limit to one or more prefetch requests which target the slice which corresponds to count variable 122. For example, the limit—when enabled—is to reject any prefetch request which targets the slice. Alternatively, the limit—when enabled—is to prevent the generation of any prefetch request which targets the slice.

In various embodiments, access tracker 120 is operable to concurrently maintain multiple count variables which are each dedicated to a different respective cache region (e.g., to a different respective one or more cache pages), wherein prefetcher 140 variously determines the respective enablement states of multiple prefetch filters each based on a different respective one of the multiple count variables. In one such embodiment, one or more of the multiple count variables are each dedicated to a different respective one (and only one) cache of processor 110—e.g., wherein a given count variable corresponds to a slice which is for some or all cache lines of a particular cache.

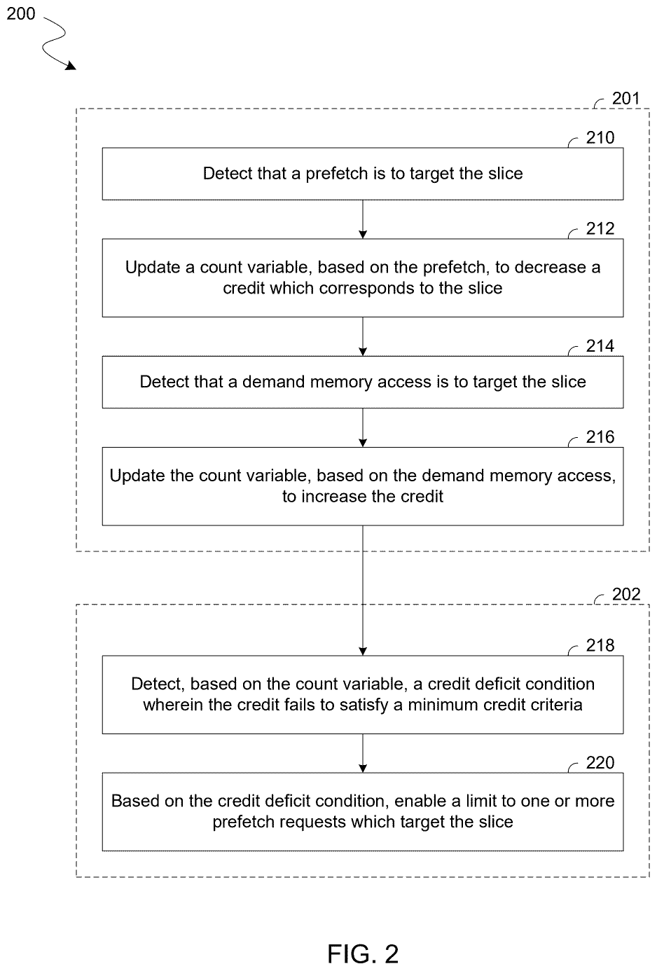

FIG. 2 shows a method 200 for maintaining a credit metric as a basis for selectively applying a prefetch filter according to an embodiment. The method 200 illustrates one example of an embodiment wherein a metric of prefetch credit is made available as a basis for determining whether prefetches to a particular memory resource is to be prevented or otherwise limited. Operations such as those of method 200 are performed with any of various combinations of suitable hardware (e.g., circuitry), firmware and/or executing software which, for example, provide some or all of the functionality of processor 110.

In some embodiments, method 200 comprises operations 201 which maintain a count variable that corresponds to a particular slice of an address space which is used by a processor. As shown in FIG. 2, operations 201 comprise (at 210) detecting that a prefetch is to target the slice in question—i.e., that the prefetch is to access a cache line, or other location in a memory resource, which is specified or otherwise indicated by an address in that slice of the address space. Based on the detection of the prefetch at 210, operations 201 (at 212) decrement of otherwise update a count variable to decrease a credit which is allocated, or otherwise corresponds, to the slice.

Operations 201 further comprise (at 214) detecting that a demand memory access is further to target the slice. Based on the detecting of the demand memory access at 214, operations 201 (at 216) update the count variable to increase the credit. For example, the updating at 216 increases of otherwise changes the count variable to indicate that the credit allocated to the slice is restored to a predetermined maximum credit level. In one such embodiment, a configuration register of the processor defines the predetermined maximum credit level—e.g., where the configuration register is accessible by a BIOS, management software or other agent which is suitable to specify or otherwise determine the maximum credit level.

In various embodiments, method 200 additionally or alternatively comprises operations 202 which determine, based on a current amount of credit allocated to a given slice, whether prefetch accesses to that slice are to be at least partially filtered. In the example embodiment shown, operations 202 comprise (at 218) detecting, based on a count variable (such as the one which is variously updated at 212 and 216), a credit deficit condition wherein a currently allocated prefetch credit fails to satisfy some minimum credit criteria. For example, the detecting at 218 comprises comparing the current value of the count variable to some reference number (e.g., zero) which corresponds to an insufficient level of prefetch credit.

Based on the credit deficit condition, operations 202 (at 220) enable a limit to one or more prefetch requests which target the slice. In some embodiments, enabling the limit at 220 comprises applying a filter which is to reject any prefetch request which targets the slice (or, alternatively, a filter which is to prevent the generation of any such prefetch requests). Alternatively or in addition, enabling the limit at 220 comprises applying a filter which is to reject only a subset of all prefetch requests which target the slice (or, alternatively, a filter which is to prevent the generation of only a subset of such prefetch requests).

In various embodiments, method 200 further comprises one or more additional operations (not shown) which conditionally disable the limit which is applied at 220. By way of illustration and not limitation, such one or more additional operations comprise detecting, while the limit is still enabled, that a later demand memory access is to target the slice in question. Based on said later demand memory access, method 200 disables the limit to prevent or otherwise reduce a filtering of prefetches which are to target the slice. In one such embodiment, the later demand memory access also results in a corresponding count variable being updated to indicate that the credit allocated to the slice has increased—e.g., to a predetermined maximum credit level as described herein.

In various embodiments, multiple instances of method 200 are variously performed—e.g., concurrently and/or in parallel with each other—to maintain count variables which are each dedicated to a different respective slice of an address space. Additionally or alternatively, multiple instances of method 200 are variously performed to conditionally enable prefetch limits each on a different respective slice. By way of illustration and not limitation, count variables are variously maintained each for a different respective slice of multiple slices which, for example, are each dedicated to a different respective one (and, in some embodiments, only one) cache. In some embodiments, two or more such count variables each correspond to a different respective minimum credit criteria, and/or each correspond to a different respective threshold maximum credit level.

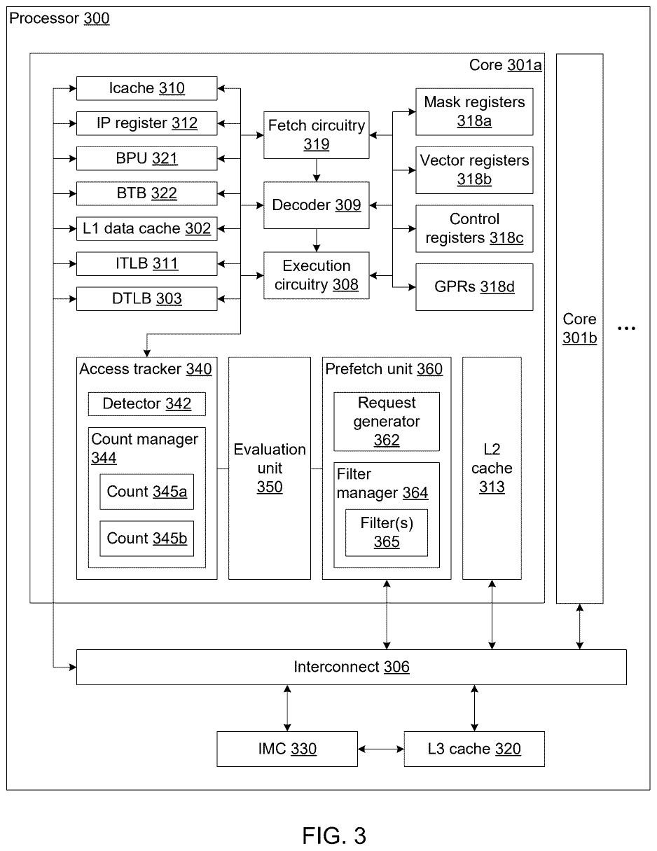

FIG. 3 shows a processor 300 which applies a prefetch filter according to an embodiment. Processor 300 illustrates features of one example embodiment wherein prefetch filtering is selectively enabled or disabled based on a metric of consumable, and recoverable, prefetch credit. In some embodiments, processor 300 provides functionality such as that of processor 110—e.g., wherein operations of method 200 are performed with some or all of processor 300.

As shown in FIG. 3, processor 300 comprises one or more processor cores (e.g., including the illustrative cores 301a, 301b), wherein a shared or “uncore” region of processor 300 comprises data structures and circuitry shared by all or a subset of the cores 301. In the illustrated embodiment, the plurality of cores 301a-b are simultaneous multithreaded cores capable of concurrently executing multiple instruction streams or threads. Although only two cores 301a-b are illustrated in FIG. 3 for simplicity it will be appreciated that the cores 301 may include any number of cores, each of which may include the same architecture as shown for core 301a. Another embodiment includes heterogeneous cores (e.g., low power cores combined with high power/performance cores). In some embodiments, circuitry of processor 300 is adapted from, and/or is incorporated with, any of various suitable processor architectures. By way of illustration and not limitation, any of various suitable embodiments of processor 300 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In the example embodiment shown, a given one of cores 301 includes instruction pipeline components for performing out-of-order (or in-order) execution of one or more instruction streams. By way of illustration and not limitation, such components comprise instruction fetch circuitry 319 which, for example, fetches instructions from system memory (not shown) or the instruction cache 310, and a decoder 309 comprising circuitry which decodes the fetched instructions. Execution circuitry 308 executes the decoded instructions to perform the underlying operations, as specified by the instruction operands, opcodes, and any immediate values.

Also illustrated in FIG. 3 are general purpose registers (GPRs) 318d, a set of vector registers 318b, a set of mask registers 318a, and a set of control registers 318c. In one embodiment, multiple vector data elements are packed into each vector register 318c which, for example, have a 512 bit width for storing two 256 bit values, four 128 bit values, eight 64 bit values, sixteen 32 bit values, etc. However, various embodiments are not limited to any particular size/type of vector data. In one embodiment, the mask registers 318a include eight 64-bit operand mask registers used for performing bit masking operations on the values stored in the vector registers 318c (e.g., implemented as mask registers k0-k7 described above). However, various embodiments are not limited to any particular mask register size/type.

The control registers 318c store various types of control bits or “flags” which are used by executing instructions to determine the current state of the processor core 301a. By way of example, and not limitation, in an x86 architecture, the control registers include the EFLAGS register.

An interconnect 306 such as an on-die interconnect (IDI) implementing an IDI/coherence protocol communicatively couples the cores 301a-b to one another and to various components within the shared region of processor 300. For example, the interconnect 306 couples core 301a to a level 3 (L3) cache 320 and an integrated memory controller (IMC) 330 which couples the processor to a system memory (not shown).

IMC 330 provides access to a system memory when performing memory operations (e.g., such as a MOV from system memory to a register). One or more input/output (I/O) circuits (not shown) such as PCI express circuitry (for example) are additionally or alternatively included in the shared region, in some embodiments.

An instruction pointer (IP) register 312 stores an instruction pointer address identifying the next instruction to be fetched, decoded, and executed. Instructions may be fetched or prefetched from system memory and/or one or more shared cache levels such as an L2 cache 313, the shared L3 cache 320, or the L1 instruction cache 310. In addition, an L1 data cache 302 stores data loaded from system memory and/or retrieved from one of the other cache levels 313, 320 which cache both instructions and data. An instruction translation lookaside buffer (ITLB) 311 stores virtual address to physical address translations for the instructions fetched by the fetch circuitry 319 and a data translation lookaside buffer (DTLB) 303 stores virtual-to-physical address translations for the data processed by the decoder 309 and execution circuitry 308.

FIG. 3 also illustrates a branch prediction unit (BPU) 321 for speculatively predicting instruction branch addresses and one or more branch target buffers—e.g., including the illustrative branch target buffer (BTB) 322 shown—for storing branch addresses and target addresses. In one embodiment, a branch history table (not shown) or other data structure is maintained and updated for each branch prediction/misprediction and is used by BPU 321 to make subsequent branch predictions.

Note that FIG. 3 is not intended to provide a comprehensive view of all circuitry and interconnects employed within a processor. Rather, components which are not pertinent to the embodiments of the invention are not shown. Conversely, some components are shown merely for the purpose of providing an example architecture in which embodiments of the invention may be implemented.

There has been extensive work on prefetching in both industry and academia over the years. Various types of prefetchers are available, and adapting one such prefetcher in a given processor design typically involves one or more trade-offs between resource complexity, timely coverage, and accuracy. Accordingly, different prefetches usually exhibit one or more relative disadvantages and/or sub-optimal characteristics in various ways.

For example, a streamer prefetcher looks for a directional trend and issues prefetches a fixed distance (8 or 16 cachelines) away from a triggering access. It does not efficiently capture non-uniform (non-streaming) access patterns to a page and is highly inaccurate in a number of cases. Spatial Memory Streaming (SMS) prefetching associates a signature—a triggering program counter (PC) and offset to a page—with an entire 64 bit pattern of subsequent accesses to the page. While more accurate and timely than Streamer prefetchers, SMS still has some major drawbacks related to area and coverage/accuracy.

A Signature Pattern Prefetcher (SP) is capable of dealing with complex non-uniform access patterns in a page. Timeliness of prefetches however is limited. Without the use of a triggering PC, it has a limited mechanism for triggering prefetches on the first access to the page. It achieves prefetch distance on subsequent accesses through a series of recursive predictions, each of lower confidence or accuracy, finally bound by a lower limit on confidence. This again puts a limit on prefetch timeliness.

To facilitate the determining of an enablement state for a prefetch filter, core 301a further comprises an access tracker 340, an evaluation unit 350, and a prefetch unit 360 which—for example—correspond functionally to access tracker 120, evaluation unit 130, and prefetcher 140 (respectively). Access tracker 340 comprises a detector 342 which is coupled to detect, for each of one or more slices of an address space, a respective access (if any) of said slice. For a given one such slice, detector 342 is able to detect either a prefetch access or a demand memory access.

In the example embodiment shown, core 301a further comprises a count manager 344 which is coupled to receive from detector 342 information which specifies or otherwise indicates, for a given slice, whether a detected access of the slice is a particular one of prefetch access type or a demand memory access type. Based on such information, count manager 344 maintains one or more count variables which, for example, correspond functionally to count variable 122. For example, count manager 344 includes or is otherwise coupled to access a table or other suitable repository of one or more count variables which each correspond to a different respective address slice. In the example embodiment shown, count manager 344 maintains a count 345a which is to be a basis for determining an enablement state of a first prefetch filter for a first address slice. Alternatively or in addition, count manager 344 maintains another count 345b which is to be a basis for determining an enablement state of a second prefetch filter for a second address slice.

In an illustrative scenario according to one embodiment, detector 342 signals count manager 344, based on the detection of a prefetch access of the first address slice, to decrement or otherwise update count 345a to decrease an amount of a prefetch credit for the first address slice. Alternatively or in addition, detector 342 signals count manager 344, based on the detection of a demand memory access of the first address slice, to increment or otherwise update count 345a to increase the amount of the prefetch credit for the first address slice. In one such embodiment, a demand memory access of the first slice results in count 345a being updated—e.g., regardless of a current value of count 345a—to a different value which indicates that the prefetch credit is at a predetermined maximum credit level. By way of illustration and not limitation, such a predetermined maximum credit level is identified by one of control registers 318c, or any of various other suitable registers of processor 300. In some embodiments, count manager 344 similarly updates count 345b at various times based on accesses of the corresponding second address slice.

In various embodiments, evaluation unit 350 provides functionality to monitor, for each of one or more count variables which are maintained with count manager 344, whether the count variable in question currently indicates a presence (or alternatively, an absence) of a respective credit deficit condition. For example, evaluation unit 350 is operable to detect a current value of count 345a, and to determine whether said current value fails to satisfy a predefined minimum credit criteria. In some embodiments, evaluation unit 350 further detects another current value of count 345b, and determines whether said other current value fails to satisfy the same (or alternatively, a different) predefined minimum credit criteria.

Based on whether a given credit deficit condition is indicated by a corresponding count variable 345, evaluation unit 350 signals prefetch unit 360 to transition an enablement state of a prefetch filter for a corresponding address slice. By way of illustration and not limitation, prefetch unit 360 comprises a request generator 362 which is to variously generate prefetch requests which are each to target (e.g., to indicate an address in) a respective one of multiple address slices. In one such embodiment, a filter manager 364 of prefetch unit 360 is operable to variously apply, or forego applying, one or more filters 365 on prefetching by request generator 362. For example, responsive to evaluation unit 350, filter manager 364 transitions a given one of filter(s) 365 between an enabled state or a disabled state—e.g., wherein the given filter is specific to a particular slice (and, correspondingly, a particular memory region associated withs said slice).

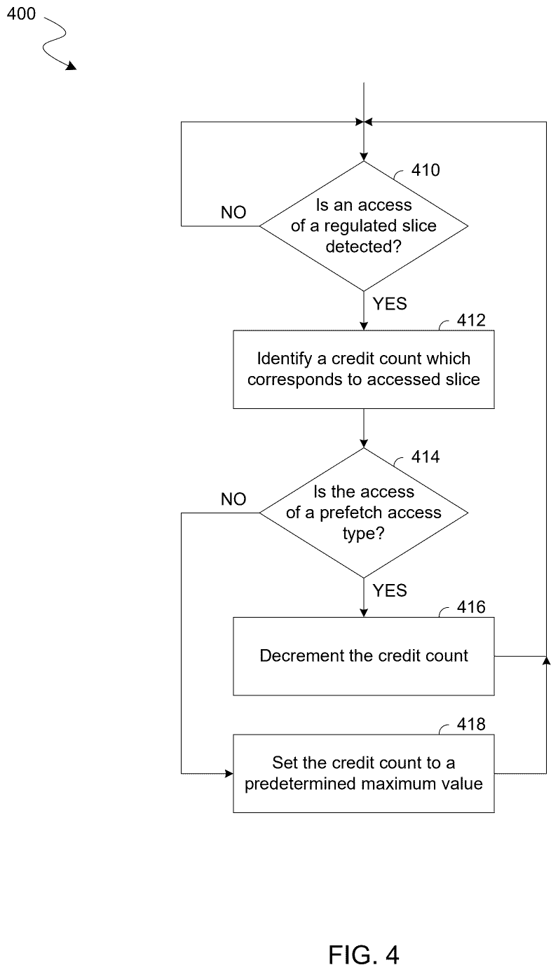

FIG. 4 shows a method 400 for determining a value of a prefetch credit metric according to an embodiment. Operations such as those of method 400 are performed with any of various combinations of suitable hardware (e.g., circuitry), firmware and/or executing software which, for example, provide some or all of the functionality of processor 110 or processor 300—e.g., wherein method 200 includes or is otherwise based on operations of method 400.

As shown in FIG. 4, method 400 comprises performing an evaluation (at 410) to determine whether an access of a regulated slice—e.g., any of multiple slices which are subject to selective regulation each with a respective prefetch filter—has been detected. For example, the evaluating at 410 is to identify a slice (if any) that has been accessed since a preceding evaluation (if any) at 410, where such access has yet to be the basis of one or more additional evaluations by method 400.

Where it is determined at 410 that no such slice has been access, method 400 repeats the evaluating at 410—e.g., until a slice access is detected. Where it is instead determined at 410 that at least one such slice has been access, method 400 (at 412) identifies a credit count which corresponds to accessed slice. For example, the credit count identified at 412 specifies or otherwise indicates an amount of prefetch credit which is currently allocated (e.g., at a per-slice granularity) to the accessed slice.

Method 400 further comprises performing another evaluation (at 414) to determine whether the access most recently detected at 410 is of a prefetch access type (e.g., as opposed to being of a demand memory access type). Where it is determined at 414 that the access in question is of the prefetch access type, method 400 (at 416) decrements or otherwise updates the corresponding credit count—which was most recently identified at 412—to indicate an incremental decrease in prefetch credit for the slice. After the decrementing at 416, method 400 performs a next instance of the evaluating at 410, in some embodiments.

Where it is instead determined at 414 that the access in question is not of the prefetch access type (but, for example, is instead of a demand memory access type), method 400 (at 418) sets the corresponding credit count to a predetermined maximum value, which indicates restored maximum prefetch credit for the slice. After the setting at 418, method 400 performs a next instance of the evaluating at 410, in some embodiments.

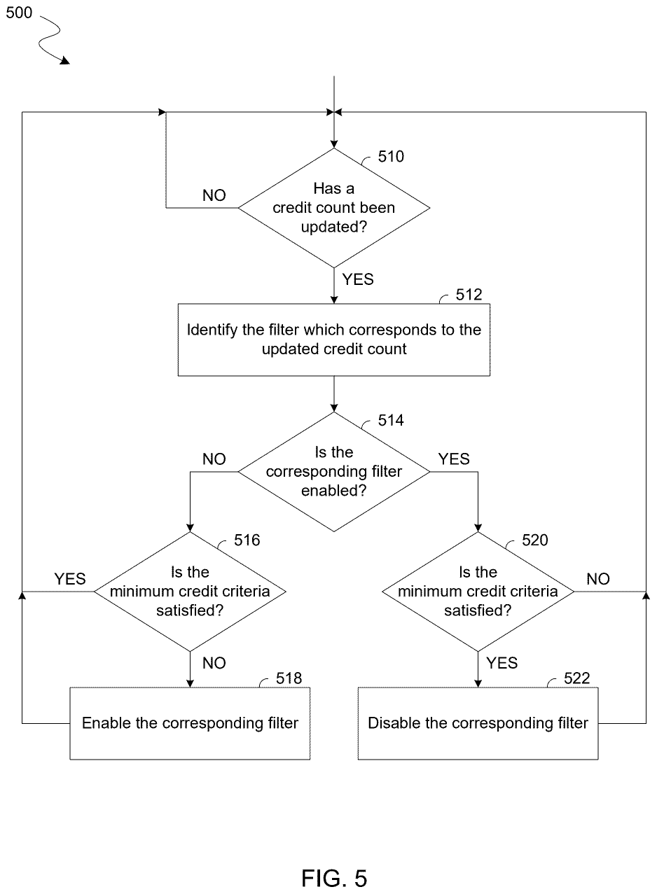

FIG. 5 shows a method 500 for determining an enablement state of a prefetch filter according to an embodiment. Operations such as those of method 500 are performed with any of various combinations of suitable hardware (e.g., circuitry), firmware and/or executing software which, for example, provide some or all of the functionality of one of processors 110, 300—e.g., wherein one of methods 200, 400 includes or is otherwise based on operations of method 400.

As shown in FIG. 5, method 500 comprises performing an evaluation (at 510) to determine whether a credit count—e.g., any of multiple credit count metrics which each correspond to a different respective slice—has been updated. For example, the evaluating at 510 is to identify a credit count (if any) that has changed since a preceding evaluation (if any) at 510, where such change has yet to be the basis of one or more additional evaluations by method 500.

Where it is determined at 510 that no such credit count has been updated, method 500 repeats the evaluation at 510—e.g., until a change to a credit count is detected. Where it is instead determined at 510 that at least one credit count has been updated, method 500 (at 512) identifies a prefetch filter which corresponds to the updated credit count—e.g., wherein the prefetch filter is specific to prefetch accesses to a particular slice, and wherein the updated credit count indicates a prefetch credit which is currently attributed to that particular slice. Method 500 further comprises performing an evaluation (at 514) to determine whether the prefetch filter, most recently identified at 512, is currently enabled. For example, the evaluation at 514 identifies an enablement state—i.e., a current one of an enabled state or a disabled state—of the identified prefetch filter.

Where it is determined at 514 that the identified prefetch filter is currently disabled, method 500 performs another evaluation (at 516) to determine whether a respective minimum credit criteria, which corresponds to the updated credit count, is currently satisfied by that credit count. Where it is determined at 516 that the corresponding minimum credit criteria is currently satisfied by the credit count, method 500 performs a next instance of the evaluating at 510. Where it is instead determined at 516 that the corresponding minimum credit criteria is not currently satisfied, method 500 (at 518) enables the corresponding prefetch filter. After the enabling at 518, method 500 performs a next instance of the evaluating at 510, in some embodiments.

Where it is instead determined at 514 that the identified prefetch filter is currently enabled, method 500 performs another evaluation (at 520) to determine whether a respective minimum credit criteria, which corresponds to the updated credit count, is currently satisfied by that credit count. Where it is determined at 520 that the corresponding minimum credit criteria is not currently satisfied, method 500 performs a next instance of the evaluating at 510. Where it is instead determined at 520 that the corresponding minimum credit criteria is currently satisfied by the credit count, method 500 (at 522) disables the corresponding prefetch filter. After the disabling at 522, method 500 performs a next instance of the evaluating at 510, in some embodiments.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors'local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4 ), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures-in-Order and Out-of-Order Core Block Diagram.

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Exemplary Execution Unit(s) Circuitry

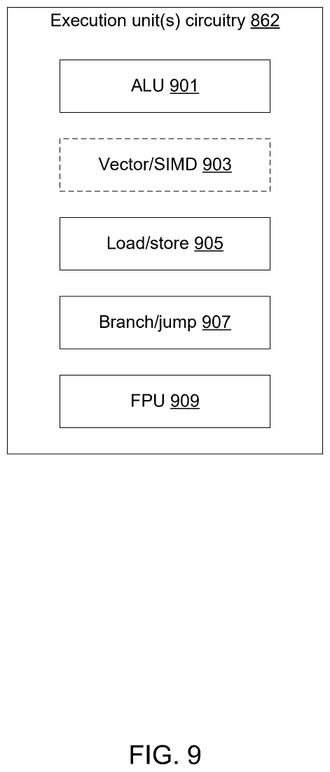

FIG. 9 illustrates examples of execution unit(s) circuitry, such as execution unit(s) circuitry 862 of FIG. 8B. As illustrated, execution unit(s) circuity 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

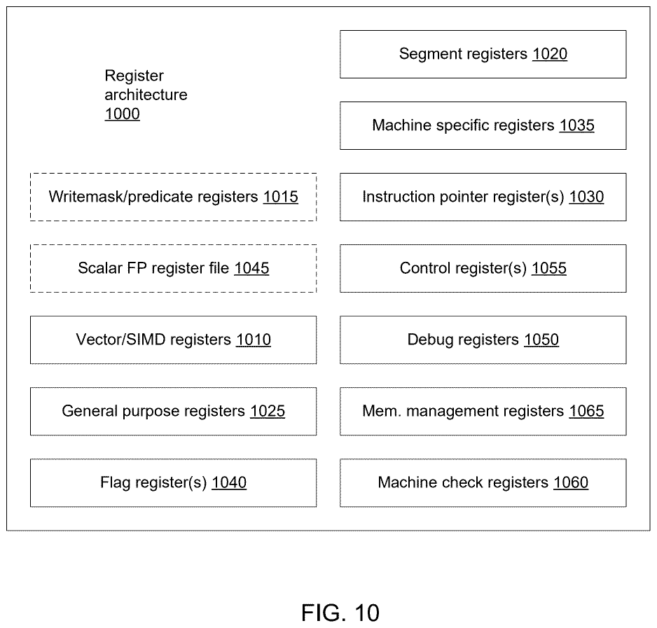

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1000 may, for example, be used in physical register file(s) circuitry 858.

Techniques and architectures for filtering prefetches are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor comprises first circuitry to maintain a count variable which corresponds to a slice of an address space, comprising the first circuitry to detect that a prefetch is to target the slice, update the count variable, based on the prefetch, to decrease a credit which corresponds to the slice, detect that a demand memory access is to target the slice, and update the count variable, based on the demand memory access, to increase the credit, second circuitry coupled to the first circuitry, the second circuitry to detect, based on the count variable, a credit deficit condition wherein the credit fails to satisfy a minimum credit criteria, and third circuitry coupled to the second circuitry, wherein, based on the credit deficit condition, the third circuitry is to enable a limit to one or more prefetch requests which target the slice.

In one or more second embodiments, further to the first embodiment, the first circuitry to update the count variable based on the demand memory access comprises the first circuitry to set the count variable to indicate that the credit is at a predetermined maximum credit level.

In one or more third embodiments, further to the second embodiment, a configuration register of the processor defines the predetermined maximum credit level.

In one or more fourth embodiments, further to the first embodiment or the second embodiment, the limit is to reject any prefetch request which targets the slice.

In one or more fifth embodiments, further to the first embodiment or the second embodiment, the limit is to prevent a generation of any prefetch request which targets the slice.

In one or more sixth embodiments, further to the second embodiment or the second embodiment, the demand memory access is a first demand memory access, while the limit is enabled, the first circuitry is to detect that a second demand memory access is to target the slice, and based on the second demand memory access the first circuitry is to set the count variable to indicate that the credit is at a predetermined maximum credit level, and the second circuitry is to signal the third circuitry, based on the count variable, to disable the limit to the one or more prefetch requests which target the slice.

In one or more seventh embodiments, further to the first embodiment or the second embodiment, the count variable, the slice, the prefetch, the credit, the demand memory access, the credit deficit condition, and the limit are, respectively, a first count variable, a first slice, a first prefetch, a first credit, a first demand memory access, a first credit deficit condition, and a first limit, while the first circuitry is to maintain the first count variable, the first circuitry is further to maintain a second count variable which corresponds to a second slice of the address space, wherein the first circuitry to maintain the second count variable comprises the first circuitry to detect that a second prefetch is to target the second slice, update the second count variable, based on the second prefetch, to decrease a second credit which corresponds to the second slice, detect that a second demand memory access is to target the second slice, and update the second count variable, based on the second demand memory access, to increase the second credit, and the second circuitry is further to detect a second credit deficit condition based on the second count variable, and signal the third circuitry, based on the second credit deficit condition, to enable a second limit to one or more prefetch requests which target the second slice.

In one or more eighth embodiments, further to the seventh embodiment, the first count variable and the second count variable are each dedicated to a different respective cache.

In one or more ninth embodiments, further to the seventh embodiment, the second credit deficit condition comprises a failure of the second credit to satisfy the minimum credit criteria.

In one or more tenth embodiments, further to the seventh embodiment, the minimum credit criteria a first minimum credit criteria, and the second credit deficit condition comprises a failure of the second credit to satisfy a second minimum credit criteria other than the first minimum credit criteria.

In one or more eleventh embodiments, a method at a processor comprises maintaining a count variable which corresponds to a slice of an address space, the maintaining comprising detecting that a prefetch is to target the slice, updating the count variable, based on the prefetch, to decrease a credit which corresponds to the slice, detecting that a demand memory access is to target the slice, and updating the count variable, based on the demand memory access, to increase the credit, detecting, based on the count variable, a credit deficit condition wherein the credit fails to satisfy a minimum credit criteria, and based on the credit deficit condition, enabling a limit to one or more prefetch requests which target the slice.

In one or more twelfth embodiments, further to the eleventh embodiment, updating the count variable based on the demand memory access comprises setting the count variable to indicate that the credit is at a predetermined maximum credit level.

In one or more thirteenth embodiments, further to the twelfth embodiment, a configuration register of the processor defines the predetermined maximum credit level.

In one or more fourteenth embodiments, further to the eleventh embodiment or the twelfth embodiment, the limit is to reject any prefetch request which targets the slice.

In one or more fifteenth embodiments, further to the eleventh embodiment or the twelfth embodiment, the limit is to prevent a generation of any prefetch request which targets the slice.

In one or more sixteenth embodiments, further to the eleventh embodiment or the twelfth embodiment, the demand memory access is a first demand memory access, the method further comprises while the limit is enabled, detecting that a second demand memory access is to target the slice, and based on the second demand memory access disabling the limit to the one or more prefetch requests which target the slice, and setting the count variable to indicate that the credit is at a predetermined maximum credit level.

In one or more seventeenth embodiments, further to the eleventh embodiment or the twelfth embodiment, the count variable, the slice, the prefetch, the credit, the demand memory access, the credit deficit condition, and the limit are, respectively, a first count variable, a first slice, a first prefetch, a first credit, a first demand memory access, a first credit deficit condition, and a first limit, and the method further comprises while maintaining the first count variable, maintaining a second count variable which corresponds to a second slice of the address space, wherein maintaining the second count variable comprises detecting that a second prefetch is to target the second slice, updating the second count variable, based on the second prefetch, to decrease a second credit which corresponds to the second slice, detecting that a second demand memory access is to target the second slice, and updating the second count variable, based on the second demand memory access, to increase the second credit, detecting a second credit deficit condition based on the second count variable, and based on the second credit deficit condition, enabling a second limit to one or more prefetch requests which target the second slice.

In one or more eighteenth embodiments, further to the seventeenth embodiment, the first count variable and the second count variable are each dedicated to a different respective cache.

In one or more nineteenth embodiments, further to the seventeenth embodiment, the second credit deficit condition comprises a failure of the second credit to satisfy the minimum credit criteria.

In one or more twentieth embodiments, further to the seventeenth embodiment, the minimum credit criteria a first minimum credit criteria, and the second credit deficit condition comprises a failure of the second credit to satisfy a second minimum credit criteria other than the first minimum credit criteria.

In one or more twenty-first embodiments, a system comprises a memory, a memory controller, a processor coupled to the memory via the memory controller, the processor comprising first circuitry to maintain a count variable which corresponds to a slice of an address space, comprising the first circuitry to detect that a prefetch is to target the slice, update the count variable, based on the prefetch, to decrease a credit which corresponds to the slice, detect that a demand memory access is to target the slice, and update the count variable, based on the demand memory access, to increase the credit, second circuitry coupled to the first circuitry, the second circuitry to detect, based on the count variable, a credit deficit condition wherein the credit fails to satisfy a minimum credit criteria, and third circuitry coupled to the second circuitry, wherein, based on the credit deficit condition, the third circuitry is to enable a limit to one or more prefetch requests which target the slice.

In one or more twenty-second embodiments, further to the twenty-first embodiment, the first circuitry to update the count variable based on the demand memory access comprises the first circuitry to set the count variable to indicate that the credit is at a predetermined maximum credit level.

In one or more twenty-third embodiments, further to the twenty-second embodiment, a configuration register of the processor defines the predetermined maximum credit level.

In one or more twenty-fourth embodiments, further to the twenty-first embodiment or the twenty-second embodiment, the limit is to reject any prefetch request which targets the slice.

In one or more twenty-fifth embodiments, further to the twenty-first embodiment or the twenty-second embodiment, the limit is to prevent a generation of any prefetch request which targets the slice.

In one or more twenty-sixth embodiments, further to the twenty-first embodiment or the twenty-second embodiment, the demand memory access is a first demand memory access, while the limit is enabled, the first circuitry is to detect that a second demand memory access is to target the slice, and based on the second demand memory access the first circuitry is to set the count variable to indicate that the credit is at a predetermined maximum credit level, and the second circuitry is to signal the third circuitry, based on the count variable, to disable the limit to the one or more prefetch requests which target the slice.

In one or more twenty-seventh embodiments, further to the twenty-first embodiment or the twenty-second embodiment, the count variable, the slice, the prefetch, the credit, the demand memory access, the credit deficit condition, and the limit are, respectively, a first count variable, a first slice, a first prefetch, a first credit, a first demand memory access, a first credit deficit condition, and a first limit, while the first circuitry is to maintain the first count variable, the first circuitry is further to maintain a second count variable which corresponds to a second slice of the address space, wherein the first circuitry to maintain the second count variable comprises the first circuitry to detect that a second prefetch is to target the second slice, update the second count variable, based on the second prefetch, to decrease a second credit which corresponds to the second slice, detect that a second demand memory access is to target the second slice, and update the second count variable, based on the second demand memory access, to increase the second credit, and the second circuitry is further to detect a second credit deficit condition based on the second count variable, and signal the third circuitry, based on the second credit deficit condition, to enable a second limit to one or more prefetch requests which target the second slice.

In one or more twenty-eighth embodiments, further to the twenty-seventh embodiment, the first count variable and the second count variable are each dedicated to a different respective cache.

In one or more twenty-ninth embodiments, further to the twenty-seventh embodiment, the second credit deficit condition comprises a failure of the second credit to satisfy the minimum credit criteria.

In one or more thirtieth embodiments, further to the twenty-seventh embodiment, the minimum credit criteria a first minimum credit criteria, and the second credit deficit condition comprises a failure of the second credit to satisfy a second minimum credit criteria other than the first minimum credit criteria.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
first circuitry to maintain a count variable which corresponds to a slice of an address space, comprising the first circuitry to:
detect that a prefetch is to target the slice;
update the count variable, based on the prefetch, to decrease a credit which corresponds to the slice;
detect that a demand memory access is to target the slice; and
update the count variable, based on the demand memory access, to increase the credit;
second circuitry coupled to the first circuitry, the second circuitry to detect, based on the count variable, a credit deficit condition wherein the credit fails to satisfy a minimum credit criteria; and
third circuitry coupled to the second circuitry, wherein, based on the credit deficit condition, the third circuitry is to enable a limit to one or more prefetch requests which target the slice.

2. The processor of claim 1, wherein the first circuitry to update the count variable based on the demand memory access comprises the first circuitry to set the count variable to indicate that the credit is at a predetermined maximum credit level.

3. The processor of claim 2, wherein a configuration register of the processor defines the predetermined maximum credit level.

4. The processor of claim 1, wherein the limit is to reject any prefetch request which targets the slice.

5. The processor of claim 1, wherein the limit is to prevent a generation of any prefetch request which targets the slice.

6. The processor of claim 1, wherein:
the demand memory access is a first demand memory access;
while the limit is enabled, the first circuitry is to detect that a second demand memory access is to target the slice; and
based on the second demand memory access:
the first circuitry is to set the count variable to indicate that the credit is at a predetermined maximum credit level; and
the second circuitry is to signal the third circuitry, based on the count variable, to disable the limit to the one or more prefetch requests which target the slice.

7. The processor of claim 1, wherein:
the count variable, the slice, the prefetch, the credit, the demand memory access, the credit deficit condition, and the limit are, respectively, a first count variable, a first slice, a first prefetch, a first credit, a first demand memory access, a first credit deficit condition, and a first limit;
while the first circuitry is to maintain the first count variable, the first circuitry is further to maintain a second count variable which corresponds to a second slice of the address space, wherein the first circuitry to maintain the second count variable comprises the first circuitry to:
detect that a second prefetch is to target the second slice;
update the second count variable, based on the second prefetch, to decrease a second credit which corresponds to the second slice;
detect that a second demand memory access is to target the second slice; and
update the second count variable, based on the second demand memory access, to increase the second credit; and
the second circuitry is further to:
detect a second credit deficit condition based on the second count variable; and
signal the third circuitry, based on the second credit deficit condition, to enable a second limit to one or more prefetch requests which target the second slice.

8. The processor of claim 7, wherein the first count variable and the second count variable are each dedicated to a different respective cache.

9. A method at a processor, the method comprising:
maintaining a count variable which corresponds to a slice of an address space, the maintaining comprising:
detecting that a prefetch is to target the slice;
updating the count variable, based on the prefetch, to decrease a credit which corresponds to the slice;
detecting that a demand memory access is to target the slice; and
updating the count variable, based on the demand memory access, to increase the credit;
detecting, based on the count variable, a credit deficit condition wherein the credit fails to satisfy a minimum credit criteria; and
based on the credit deficit condition, enabling a limit to one or more prefetch requests which target the slice.

10. The method of claim 9, wherein updating the count variable based on the demand memory access comprises setting the count variable to indicate that the credit is at a predetermined maximum credit level.

11. The method of claim 10, wherein a configuration register of the processor defines the predetermined maximum credit level.

12. The method of claim 9, wherein the limit is to reject any prefetch request which targets the slice.

13. The method of claim 9, wherein the limit is to prevent a generation of any prefetch request which targets the slice.

14. The method of claim 9, wherein:
the demand memory access is a first demand memory access;
the method further comprises:
while the limit is enabled, detecting that a second demand memory access is to target the slice; and
based on the second demand memory access:
disabling the limit to the one or more prefetch requests which target the slice; and
setting the count variable to indicate that the credit is at a predetermined maximum credit level.

15. A system comprising:
a memory;
a memory controller;
a processor coupled to the memory via the memory controller, the processor comprising:
first circuitry to maintain a count variable which corresponds to a slice of an address space, comprising the first circuitry to:
detect that a prefetch is to target the slice;
update the count variable, based on the prefetch, to decrease a credit which corresponds to the slice;
detect that a demand memory access is to target the slice; and
update the count variable, based on the demand memory access, to increase the credit;
second circuitry coupled to the first circuitry, the second circuitry to detect, based on the count variable, a credit deficit condition wherein the credit fails to satisfy a minimum credit criteria; and
third circuitry coupled to the second circuitry, wherein, based on the credit deficit condition, the third circuitry is to enable a limit to one or more prefetch requests which target the slice.

16. The system of claim 15, wherein the first circuitry to update the count variable based on the demand memory access comprises the first circuitry to set the count variable to indicate that the credit is at a predetermined maximum credit level.

17. The system of claim 16, wherein a configuration register of the processor defines the predetermined maximum credit level.

18. The system of claim 15, wherein the limit is to reject any prefetch request which targets the slice.

19. The system of claim 15, wherein the limit is to prevent a generation of any prefetch request which targets the slice.

20. The system of claim 15, wherein:
the demand memory access is a first demand memory access;
while the limit is enabled, the first circuitry is to detect that a second demand memory access is to target the slice; and
based on the second demand memory access:
the first circuitry is to set the count variable to indicate that the credit is at a predetermined maximum credit level; and
the second circuitry is to signal the third circuitry, based on the count variable, to disable the limit to the one or more prefetch requests which target the slice.
